(19) United States
(12) Patent Application Publication
(10) Pub. No.: US 2002/0126143 A1
(43) Pub. Date: Sep. 12, 2002

(54) Article-based news video content summarizing method and browsing system

(75) Inventors: So Young Bae, Gyeonggi-do (KR); Sung Bae Jun, Seoul (KR); Kyoung Ro Yoon, Seoul (KR)

Correspondence Address: FLESHNER & KIM, LLP, P.O. Box 221200, Chantilly, VA, 20153-1200, US

(73) Assignee: LG Electronics, Inc.

(21) Appl. No.: 10/092,545

(22) Filed: Mar. 8, 2002

(30) Foreign Application Priority Data
Mar. 9, 2001 (KR) 12185/2001

(51) Int. Cl. G09G 5/00

(52) U.S. Cl. 345/723; 345/716; 345/756

(57) ABSTRACT

The present invention relates to a method that can effectively summarize news video and an article-based video-browsing system that enables effective searching and filtering using the method.

The present invention provides an article-based news video content summary method, browsing interface and browsing system that summarize and browse at least one news article by using an anchor key frame, an episode key frame, a synthetic text key frame and a news icon of the news video stream. The anchor key frame is extracted from an anchor shot. The episode key frame is extracted from an episode scene. The synthetic text key frame is generated by summarizing important texts in video frames n the news article to be an image. The news icon includes an image, graphical element and so forth, which appear in an anchor shot to summarize contents of the news article.

### BACKGROUND OF THE INVENTION

1. Field of the Invention

The present invention relates to a multimedia summary and browsing system for a content-based multimedia searching and browsing, and particularly to a method for effectively summarizing news video and an article-based video-browsing system enabling effective searching and filtering using the method.

More particularly, the present invention relates to a method for summarizing a news video based on a news article, and a browsing interface and system for browsing summarized news video based on a news article.

2. Description of the Related Art

With the development of digital video technology and image/video/audio recognition technology, it has been possible for a user to search, filter and browse a desired multimedia content at a desired time.

Shot segmentation and shot clustering technologies are the most fundamental technologies for a non-linear multimedia content browsing and searching. These are essential technologies for structurally analyzing a multimedia content.

FIG. 1 is intended to aid understanding of structure information of a video stream.

In a video, a shot is defined as a sequence of video frames taken from the same camera with no interruption. The shot is the most basic unit of analysis or construction of a video.

Further, the video is composed of a collection of scenes that are meaningful division elements of a story or video construction. Generally, there are several shots within one scene. The concept of the shot and scene can be applied to an audio program as well as the video.

The ultimate object of a multimedia content indexing technology is that a user is able to easily browse or search desired portions of information by extracting structure information on the basis of a shot/scene from a multimedia content, extracting an important feature element such as key frames. Key frames represent corresponding segment from extracted structure information to index the extracted structure information in such a manner as to describe meaningful information on a time axis. The meaningful information may include, for example, occurrence of an event, appearance of an audio-visual object, state of an object, background (for example, a place), and so forth.

Generally, in a multimedia content, a news video stream is a structured and fixed pattern of video data and uses a fixed pattern of a spatial/temporal structure.

Namely, the news video stream is different from a general multimedia stream in that it is composed of several articles, and each of the articles is composed of a brief description by a news anchor and an episode supporting the contents thereof.

FIG. 2 shows an example of a news video structure.

As shown in this drawing, one news video stream is composed of several articles, and each of the articles is composed of a brief description (corresponding to an anchor shot) of a news anchor and a data video (or an episode) supporting the contents thereof. From the content's point of view, there are various articles about politics, economics, society, sports and weather in general news. So, it can be considered that a news video has a fixed pattern of structure, unlike from a video content of a different genre such as a drama. Accordingly, the user may be interested in a specific article in the news video stream and want to easily search only the desired news article.

FIG. 3 shows a relationship between an anchor frame and a news icon (which is composed of a meaningful image and/or text information indicating specific contents of the article) in a news video structure having a fixed pattern such as shown FIG. 2.

As describe above, the user wants to easily search only a desired news article. In order to satisfy such a user request in a video indexing aspect, various researches have been performed to index a news video stream on the basis of an article unit using structure/meaningful information of a news video.

In detail, the research has been directed to a variety of nonlinear news video browsing technologies that combine news video data indexed on the basis of a news article unit using a temporal structure of the news video with an interface such as a table of contents (TOC) or storyboard.

FIG. 4 shows the TOC as an example of the nonlinear news video browsing interface.

The interface such as the TOC or storyboard is a means for transferring summarized contents of the video stream to the user by means of an image, and TOC or storyboard is often used in nonlinear video browsing. However, a summarizing interface of a TOC type has a disadvantage that it is difficult to control operation_and the user has to thoroughly browse through key frames of a lower layer node to identify contents of a news article. In the TOC interface, each node is a scene or shot and is represented by an image for the purpose of an easy understanding. It is very difficult to select a key frame capable of representing each article (or a scene) when constructing the TOC interface with respect to the news video. In a summarizing method of a simple storyboard type, it is hard to effectively transfer the information about a scene that is a substantial unit of a story development to the user. So, the storyboard is an inefficient method to summarize the news article. Further, the above two conventional summarizing methods are disadvantageous in that it is difficult to intuitionally transfer the entire news contents to the user.

### SUMMARY OF THE INVENTION

Therefore, the present invention is directed to a method for summarizing a news video stream based upon a news article, a browsing interface and a system for browsing summarized news video based upon a news article that substantially obviates one or more problems due to limitations and disadvantages of the related art.

It is an object of the present invention to provide an article-based news video content summary method, browsing interface and browsing system that can perform a more effective summarization of contents of a news video on the basis of a news article, and display a user's desired news article using the summarized contents as the browsing interface.

It is a further object of the present invention to provide an article-based news video content summarizing method, browsing interface and browsing system that enable an intuitional understanding and easy selection of a desired news article only using meaningful/structured index information about news video data.

To achieve the above objects and other advantages and in accordance with the purpose of the present invention, as embodied and broadly described herein, there is provided an article-based news video content summary method that divides the news video content on the basis of a news article unit, extracts an anchor key frame, an episode key frame and a text key frame associated with the corresponding news article from the news video content divided on the basis of the news article unit, and indexes the anchor key frame, the episode key frame and the text key frame as summary elements for representing the news article.

To achieve the above objects and other advantages and in accordance with the purpose of the present invention, there is also provided an article-based news video content browsing interface that summarizes a news article of a news video content as a one-dimensional image list using an anchor key frame, episode key frame and text key frame, divides the news video content in a unit of news article, provides the divided news video content to a user and displays entire news content on a two-dimensional display area without any additional user input request,.

To achieve the above objects and other advantages and in accordance with the purpose of the present invention, there is further provided an article-based news video content browsing system which provides a function of browsing a news video on the basis of a news article by displaying the news video divided in a unit of news article on a two-dimensional display area, providing a two-dimensional display interface represented by an anchor key frame, episode key frame, text key frame, news icon key frame and the like, and providing a user input interface for allowing a user to select a desired news article and playing the selected news article.

The present invention provides an article-based news video content summary method, browsing interface and browsing system which can summarize a news video content by arranging representative information representing at least one news article of the news video content together with summary information generated by summarizing contents of the news article, provide the summary of the contents of the news article, play/display a news article desired by a user through a provided news video interface.

The present invention further provides an article-based news video content summary method, browsing interface and browsing system which can summarize and browse at least one news article by using an anchor key frame, episode key frame, synthetic text key frame and news icon. The anchor key frame is extracted from an anchor shot. The episode key frame is extracted from an episode scene. The synthetic text key frame is generated by summarizing important texts in video frames within the news article to be an image. The news icon includes an image, graphical element and so forth, which appear in an anchor shot to summarize contents of the news article.

In accordance with one aspect of the present invention, a method for summarizing a news video content based on a news article comprises the steps of a) dividing the news video content on the basis of a news article unit; b) extracting an anchor key frame, an episode key frame and a synthetic text key frame associated with the corresponding news article from the news video content divided on the basis of the news article unit; and c) indexing the anchor key frame, the episode key frame and the synthetic text key frame as summary elements for representing the news article.

In accordance with another aspect of the present invention, an article-based news video content browsing interface is characterized in that it summarizes a plurality of news articles in a news video content to create image lists using summary elements including an anchor key frame, an episode key frame and a synthetic text key frame, and displays entire news video contents summarized on the basis of a news article unit on a display area.

In accordance with yet another aspect of the present invention, an article-based news video content browsing system comprises a means for providing a summarized news video content for each news article using summary elements including an anchor key frame, an episode key frame and a text key frame; means for displaying summary contents of the news video content summarized using the summary elements; input means for enabling a user to browse and select the news article using the display means; and means for playing a specific news article using the display means if the news article is selected by the user.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore not to be considered limiting of its scope, the invention will be described with additional specificity and detail through use of the accompanying drawings, in which:

FIG. 1 is a view intended to aid understanding of structured information of a video stream;

FIG. 2 a view illustrating an example of a news video structure; FIG. 3 is a view illustrating a relationship between an anchor frame and a news icon in a news video;

FIG. 4 a view illustrating a TOC as an example of a nonlinear video browsing interface;

FIG. 5 is a view illustrating an example of a synthetic key frame;

FIG. 6 is a view illustrating an example of an article-based browsing interface composed of four key frames in a news video; and

FIG. 7 is a block diagram showing the construction of a system for a nonlinear play control.

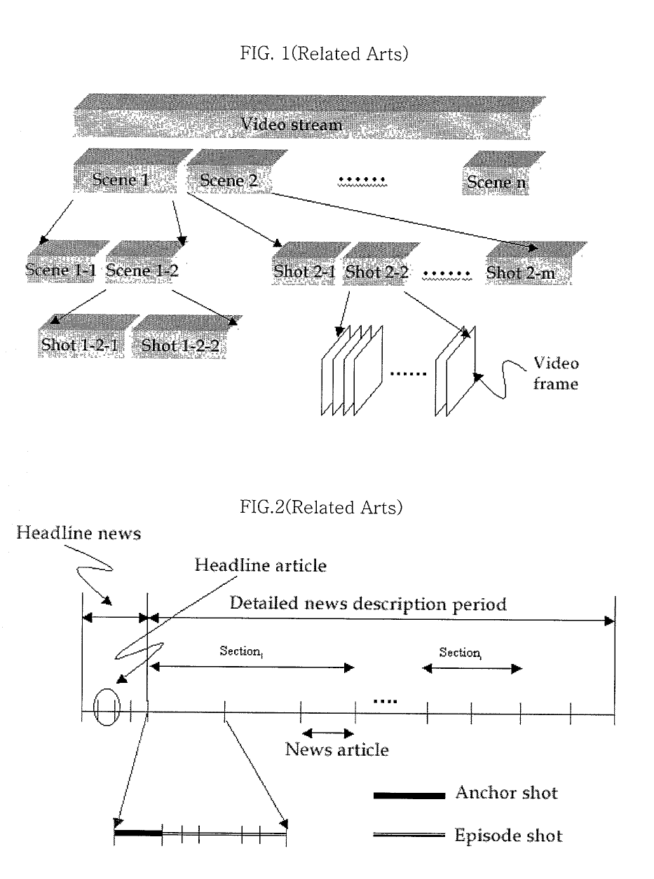

### DESCRIPTION OF THE PREFERRED EMBODIMENTS

The following detailed description of the embodiments of the invention is not intended to limit the scope of the invention, as claimed, but is merely representative of the presently preferred embodiments of the invention. In the description, same drawing reference numerals are used for the same elements even in different drawings. The matters defined in the description are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

As shown in FIGS. 2 and 3, generally, a news video stream is a formalized/structured video data and uses a fixed pattern of a spatial/temporal structure. One news video stream is composed of several articles, and each of the articles is composed of a brief description (corresponding to an anchor shot) of a news anchor and a data video (or an episode) supporting the contents thereof. From the content's point of view, there are various articles about politics, economics, society, sports and weather in general news. So, unlike from a video content of a different genre such as a drama, a news video has a fixed pattern. A user may be interested in a specific article of news and want to easily search only the desired news article. In order to satisfy this user's desire in a video indexing aspect, various researches have been made to index a news video stream on the basis of an article unit using structured/meaningful information of a news video.

In most video indexing systems, a key frame is extracted to represent a scene and shot as structure elements of an extracted video stream, and the extracted key frame is used in searching and browsing. The key frame is an image frame that is extracted from a video sequence to express a unit segment well.

Besides the key frame representing the scene or shot of the video stream, a video browsing interface technology using a key region has been proposed. This video browsing interface technology is applicable to a specific application field such as news video indexing.

In such a video browsing interface technology, a news icon existing in an anchor shot is selected as the key region and extracted to be used as a means representing the corresponding news article. FIG. 3 graphically shows a relationship between an anchor frame and the news icon. Generally, the key region indicates a region implying contents of a video segment such as a text, human face, news icon, etc. The key region can be used as a nonlinear browsing interface for a video summary or the video stream because it expresses meaningful information of the video stream.

Color distribution characteristics, an aspect ratio, motion information and so forth are used to extract the text, a region of the human face or the news icon from the video stream.

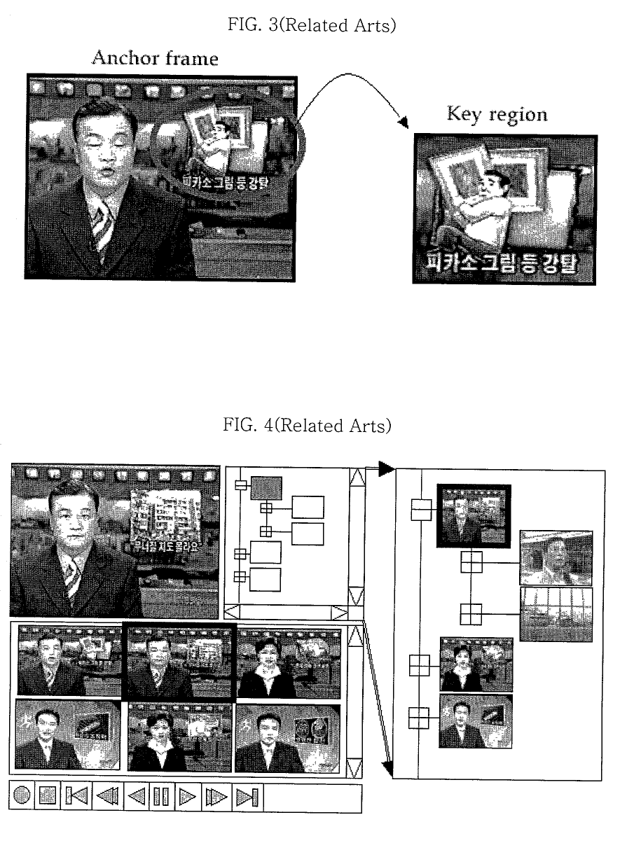

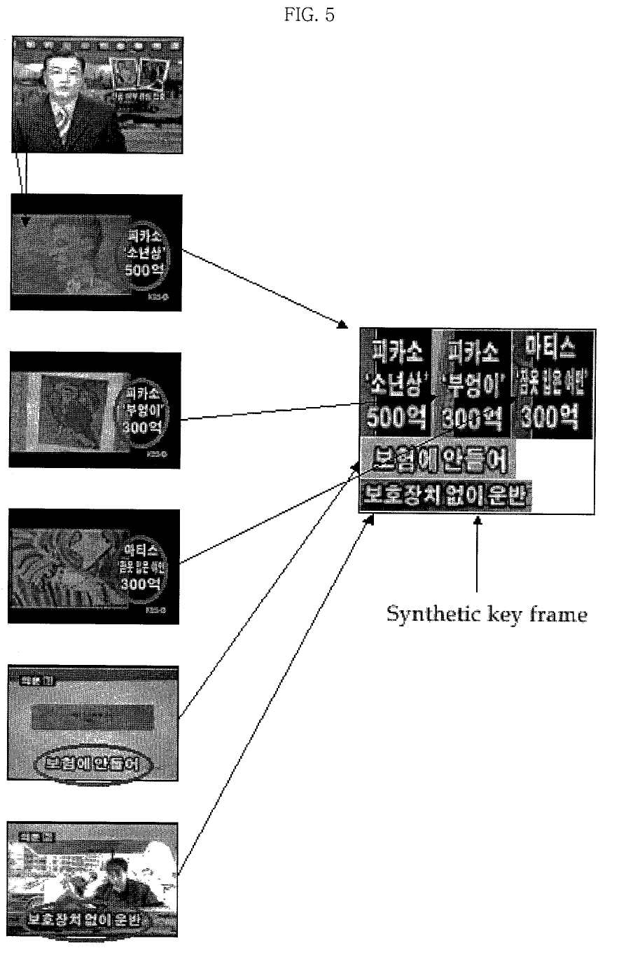

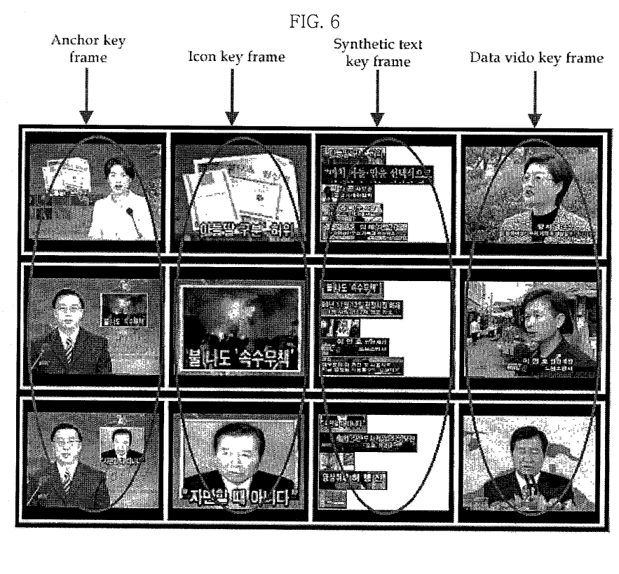

There has been proposed various nonlinear news video browsing technologies which combine news video data indexed in a unit of a news article with an interface such as a table of contents (TOC) or storyboard using a temporal structure of the news video (refer to FIG. 4).

The present invention also provides a new video browsing interface that enables an intuitional understanding and a simple selection of a desired news article only, using meaningful/structured index information of the news video data.

The browsing interface according to the present invention summarizes each of the news articles of the news video using an anchor key frame, an episode key frame, a synthetic text key frame and a news icon. The anchor key frame is extracted from an anchor shot. The episode key frame is extracted from an episode scene. The synthetic text key frame is generated by summarizing important texts in video frames in each of the news articles to be converted into an image. The news icon includes an image, graphical element and so forth that appear in an anchor shot to summarize contents of the news article.

Using the browsing interface according to the present invention, a user can rapidly understand the entire contents of a news article, get desired contents in a short time, and easily perform selective browsing only necessary news articles, as compared with the TOC or storyboard interface.

FIG. 6 is a view illustrating a picture configuration method in the browsing interface based on a news article according to the present invention.

As shown in this drawing, the browsing interface is formed by combining four key frames, that is, the anchor key frame, an icon key frame, the synthetic text key frame, a data video key frame, thereby forming a basic unit for summarization and browsing of the news article.

By summarizing and displaying the news video as shown in FIG. 6, it is possible to express the news articles more effectively than the storyboard method which simply arranges key frames in a limited region. In the browsing interface, the news articles can be effectively differentiated from each other by the anchor key frame in a region where maximum four key frames per article can be expressed. The news icon which is generated to effectively summarize/transfer the contents of each of the articles can be enlarged and then presented so as to enhance the effectiveness of summary/comprehension of the contents.

The synthetic text key frame is used to provide a summary of important video text included in each of the articles. It is possible to provide supplementary information, which the news icon cannot give, using the synthetic text key frame.

The data video key frame is additionally used to provide a visual summary of the contents of each of the news articles. In a hierarchical structure of the conventional TOC method, presentation of lower layer nodes for browsing cannot be implemented in a limited region. Even if it is possible to show the lower layer nodes in the TOC method, the region is insufficient to show all of the lower layer nodes, causing the effectiveness of a content comprehension being lowered and an inconvenience in control. On the contrary, the present invention can provide a user interface, which is more effective in user control than the hierarchical structure of the TOC method, by plane presentation of each of the news articles.

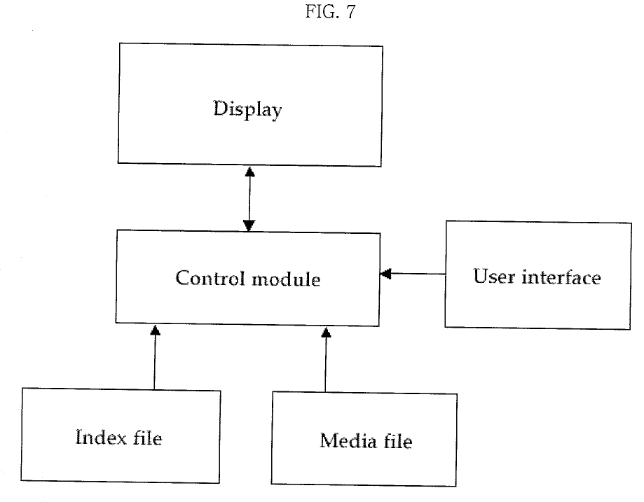

FIG. 7 is a block diagram showing an example of the construction of an article-based news video browsing system for presenting a video content in such a way that a news article selected by a user starts to be played from a play reopening position, that is, its beginning position in response to a user's request for playing the news article.

The browsing system of the present invention comprises a display, a control module, a user interface, a media file and an index file.

The display is an output unit such as a monitor, a speaker or the like. The user interface is an input unit such as a keyboard, mouse, remote controller or the like with which the user can select a desired news article in a unit of news article. The media file stores video data. The index file stores index information and news article summary information. The index information includes information about beginning and ending positions of the news article. The news article summary information includes information about the anchor key frame, episode key frame, synthetic text key frame, icon key frame and the like.

The control module is operated to process a user input, to select a part or the whole of an appropriate media file to be played based on the index file, to appropriately play the selected media file. The control module, further, controls the display, and provides and presents information requested through the user interface on the basis of the index information.

If the user selects a news article through the news video browsing system and requests the playing of the selected news article, the control module fetches information about beginning and ending positions of the news article selected based on the user input from the index file that is previously loaded in a memory. Then, the control module extracts information about beginning and ending positions of a media file corresponding to the selected news article, and outputs the video content corresponding to the news article to the display such that the news article starts to be played from a play reopening position, that is, its beginning position of the selected news article.

As apparent from the above description, the present invention provides an article-based news video content summarizing method and browsing system, which enable an easy understanding and a simple selection of a desired news article using meaningful/structured information about news video data.

The browsing interface according to the present invention summarizes each of the news articles of the news video using an anchor key frame, episode key frame, synthetic text key frame and news icon. The anchor key frame is extracted from an anchor shot. The episode key frame is extracted from an episode scene. The synthetic text key frame is generated by summarizing important texts in a video frame in each of the news articles to be inverted into an image. The news icon includes an image, graphical element and so forth, which appear in an anchor shot to summarize contents of the news.

The browsing system enables a user to rapidly understand the entire contents of a news article, get desired contents in a short time, and easily perform selective browsing of necessary news article only, as compared with the TOC or storyboard interface.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for summarizing a news video content based on a news article, comprising the steps of:
a) dividing the news video content on the basis of a news article unit;
b) extracting an anchor key frame, an episode key frame and a text key frame associated with a corresponding news article from the news video content divided on the basis of news article units; and
c) indexing the anchor key frame, the episode key frame and the text key frame as summary elements for representing the news article.

2. The method as set forth in claim 1, further comprising the steps of:
d) extracting a news icon as an element for summarizing the news article as well as the anchor key frame, the episode key frame and the text key frame; and
e) storing the extracted news icon as an image to generate a news icon key frame;
wherein the generated news icon key frame is used as an additional summary element for summarizing the news article.

3. The method as set forth in claim 1 or claim 2, wherein the anchor key frame is extracted from an anchor shot of the news article.

4. The method as set forth in claim 1 or claim 2, wherein the episode key frame is extracted from an episode scene within the news article and represents the episode scene.

5. The method as set forth in claim 1 or claim 2, wherein the text key frame is a summary that key texts scattered in the news article and representative of contents of the news article are synthesized in an image.

6. An article-based news video content browsing interface characterized in that it summarizes a plurality of news articles in a news video content to create image lists using summary elements including an anchor key frame, an episode key frame and a text key frame, and displays a whole of the news video content summarized on the basis of a news article unit on a display area.

7. The browsing interface as set forth in claim 6, wherein the browsing interface extracts a news icon as an element for summarizing each of the news articles as well as the anchor key frame, the episode key frame and the text key frame, and stores the extracted news icon as an image to generate a news icon key frame such that the generated news icon key frame is used as an additional summary element for summarizing each of the news articles.

8. The browsing interface as set forth in claim 6 or claim 7, wherein the anchor key frame is extracted from an anchor shot of each of the news articles.

9. The browsing interface as set forth in claim 6 or claim 7, wherein the episode key frame is extracted from an episode scene within each of the news articles to represent the episode scene.

10. The browsing interface as set forth in claim 6 or claim 7, wherein the text key frame is a summary that key texts scattered in each of the news articles and representative of contents of each news article are synthesized in an image.

11. The browsing interface as set forth in claim 6 or claim 7, wherein the browsing interface is displayed in such a way that the summary elements of each of the news articles are arranged in a corresponding part of the display area.

12. The browsing interface as set forth in claim 11, wherein the news articles are arranged on one axis of abscissa and ordinate axes of the display area, and summary elements of each news article are arranged on the other axis.

13. An article-based news video content browsing system comprising:
means for providing summarized news video contents for each news article using summary elements including an anchor key frame, an episode key frame and a text key frame;
means for displaying summary contents of the news video content summarized using the summary elements;
input means for enabling a user to browse and select the news article using the display means; and
means for playing a specific news article using the display means if the news article is selected by the user.

14. The browsing system as set forth in claim 13, wherein the summary elements include a news icon as well as the anchor key frame, the episode key frame and the text key frame, wherein the news icon is extracted to summarize each news article and stored as an image to generate a news icon key frame, and wherein the generated news icon key frame is used as an additional summary element for summarizing each of the news articles.

15. The browsing system as set forth in claim 13 or claim 14, wherein the anchor key frame is extracted from an anchor shot of each of the news articles, wherein the episode key frame is extracted from an episode scene within each of the news articles to represent the episode scene, and wherein the text key frame is a summary that key texts scattered in each of the news articles are synthesized in an image.

16. The browsing system as set forth in claim 13 or claim 14, wherein the browsing interface represented by the display means divides a display area for each news article, and wherein the browsing interface is implemented as an arrangement of the summary elements for each of the news articles in a corresponding part of each display area.

17. The browsing system as set forth in claim 13 or claim 14, wherein the video content is presented from a play reopening start position that is a beginning position of the selected news article when user requests a play of selected news article.

18. An article-based news video content browsing system comprising:
means for summarizing a news video content by arranging information representing at least one news article of the news video content together with information summarizing contents of the news article;
means for providing a user with summarized contents of the news article as a browsing interface; and
means for playing and displaying a specific section the user wants to get from the provided browsing interface.

19. The browsing system as set forth in claim 18, wherein any one of the information representing an article of the news video or summary information of the news video is generated by performing any one of selection or combination operation with respect to at least one of an anchor key frame, an episode key frame, a text key frame and a news icon.
